(19) United States
(12) Patent Application Publication
(10) Pub. No.: US 2025/0167282 A1
(43) Pub. Date: May 22, 2025

(54) ISOSTATIC PRESSING DEVICE FOR ALL SOLID RECHARGEABLE BATTERY

(71) Applicants: SAMSUNG SDI CO., LTD., Yongin-si (KR); HYUNDAI MOTOR COMPANY, Seoul (KR); KIA CORPORATION, Seoul (KR)

(72) Inventors: Mansoo SHIN, Yongin-si (KR); Jeonghoon KIM, Yongin-si (KR); Hyoupje CHO, Seoul (KR); Jaeho CHUN, Seoul (KR)

(21) Appl. No.: 18/820,352

(22) Filed: Aug. 30, 2024

(30) Foreign Application Priority Data
Nov. 22, 2023 (KR) 10-2023-0163640

(51) Int. Cl. H01M 10/04; H01M 10/48

(52) U.S. Cl. CPC H01M 10/0481; H01M 10/486

(57) ABSTRACT

An isostatic pressing device for an all solid rechargeable battery is disclosed. The isostatic pressing device includes a yoke, a vessel installed inside the yoke, a cover provided on the yoke side to close and open an inlet and an outlet on the vessel, and a thermocouple installed in a hole in the cover to detect a temperature of a pressed medium in the vessel, in which a temperature measuring tip in the thermocouple protrudes from the hole of the cover to an inner surface of the cover and is in thermal contact with the pressed medium.

### CROSS-REFERENCE TO RELATED APPLICATION

This application claims priority to and the benefit of Korean Patent Application No. 10-2023-0163640 filed in the Korean Intellectual Property Office on Nov. 22, 2023, the entire contents of which are incorporated herein by reference.

### BACKGROUND OF THE DISCLOSURE

### (a) Field of the Invention

The present disclosure relates to an isostatic pressing device for an all solid rechargeable battery that applies high pressure to the all solid rechargeable battery in order to isostatically press the all solid rechargeable battery and make a solid electrolyte dense during the all solid rechargeable battery manufacturing process.

### (b) Description of the Related Art

Development of batteries with high energy density and safety has been actively conducted. For example, lithium-ion batteries are being put into practical use not only in the fields of information-related devices and communication devices, but also in the automobile field. In the automotive field, safety of the lithium-ion battery may be important.

Some lithium-ion batteries currently on the market use an electrolyte solution containing a flammable organic solvent, so there is a possibility of overheating and fire if a short circuit occurs. In response to this, a solid rechargeable battery (also called a “solid state battery”) using a solid electrolyte instead of an electrolyte solution has been proposed.

By minimizing an amount of the flammable organic solvent (e.g., by not using a flammable organic solvent), a solid rechargeable battery may reduce the possibility of fire or explosion even if a short circuit occurs. Therefore, an solid rechargeable battery may greatly increase safety compared to the lithium-ion battery using an electrolyte solution.

The above-described information disclosed in background section of the present disclosure is only for improving understanding of the background of the present disclosure, and therefore may include information that does not constitute the related art.

### SUMMARY OF THE DISCLOSURE

The present disclosure provides an isostatic pressing device for a solid rechargeable battery that generates high pressure during a densification process of a solid electrolyte in a solid rechargeable battery manufacturing process.

According to an embodiment of the present disclosure, an isostatic pressing device for a battery includes a yoke, a vessel installed inside the yoke, a cover provided on the yoke side to close and open an inlet and an outlet on the vessel, and a thermocouple installed in a hole in the cover and configured to detect a temperature of a pressed medium in the vessel, in which a temperature measuring tip in the thermocouple protrudes from the hole on the cover to an inner surface of the cover and is in thermal contact with the pressed medium.

The isostatic pressing device may further include a block inserted between the cover and the yoke.

The temperature measuring tip may protrude by a length that is shorter than an interval between the inner surface of the cover and the vessel when the vessel moves to the pressed position.

The temperature measuring tip may protrude 5 mm to 20 mm from the inner surface of the cover.

The cover may further include a front plate formed on an inner surface of the cover, and the front plate may include an extension hole to extend the hole in the cover.

The temperature measuring tip may protrude from the extension hole of the front plate, and the temperature measuring tip may protrude 5 mm to 20 mm from the inner surface of the front plate.

According to another embodiment of the present disclosure, an isostatic pressing device for a battery includes: a yoke; a vessel installed inside the yoke; a cover provided on the yoke side to close and open an inlet and an outlet on the vessel; and a thermocouple installed in a hole in the cover to detect a temperature of a pressed medium in the vessel, in which the cover has an expansion groove formed on an inner surface of the cover having a diameter that is larger than that of the hole, the thermocouple comprises a temperature measuring tip that protrudes from the expansion groove to the inner surface of the cover and is in thermal contact with the pressed medium.

The expansion groove of the cover may have a diameter of from 5 mm to 20 mm and a depth of 5 mm to 20 mm.

The cover may further include a front plate formed on an inner surface of the cover, and the expansion groove may be formed in the front plate, and the temperature measuring tip may be spaced apart from an inner surface of the expansion groove by a length equal to a radius of the expansion groove.

The temperature measuring tip may protrude from an extension groove of the front plate by a protruding length, and the protruding length of the temperature measuring tip may be less than a maximum height of the expansion groove.

The expansion groove of the front plate may have a diameter of 5 mm to 20 mm and a depth of 5 mm to 20 mm.

The temperature measuring tip may further protrude shorter than an interval between the inner surface of the front plate and the vessel when the vessel moves to the pressed position.

The cover may further include an extension groove connected to the expansion groove, and the temperature measuring tip may be bent in the expansion groove and spaced apart from an inner surface of the expansion groove and an inner surface of the extension groove.

The temperature measuring tip may be bent at a right angle in the expansion groove and disposed in the extension groove, the expansion groove of the front plate may have a diameter of 5 mm to 20 mm and a depth of 5 mm to 20 mm, and a width of the extension groove may be 5 mm to 20 mm.

The cover may include a front plate formed on an inner surface of the cover, the front plate may further include an extension groove connected to the expansion groove, and the temperature measuring tip may be bent in the expansion groove and spaced apart from an inner surface of the expansion groove and an inner surface of the extension groove.

The temperature measuring tip may be bent at a right angle in the expansion groove and may be disposed in the extension groove, the expansion groove of the front plate may have a diameter of 5 mm to 20 mm and a depth of 5 mm to 20 mm, and a width of the extension groove may be 5 mm to 20 mm.

The temperature measuring tip may protrude by a length that is shorter than an interval between the inner surface of the cover and the vessel when the vessel moves to the pressed position.

According to the isostatic pressing device of an embodiment, by protruding the temperature measuring tip of the thermocouple from the inner surface of the cover and directly contacting the pressed medium in the internal space of the vessel, it is possible to accurately measure and monitor the temperature of the pressed medium.

According to the isostatic pressing device of an embodiment, by forming the expansion groove on the inner surface of the cover and protruding the temperature measuring tip of the thermocouple into the expansion groove and exposing the temperature measuring tip to the pressed medium located inside the expansion groove, it is possible to accurately measure and monitor the temperature level of the pressed medium.

In addition, according to an embodiment, by reducing or preventing the thermocouple provided on the cover from interfering with or colliding with the vessel during the opening and closing operation of the cover and the conveying operation of the vessel, it is possible to ensure process stability.

### BRIEF DESCRIPTION OF THE DRAWINGS

FIG. 1 is a longitudinal cross-sectional view illustrating a solid rechargeable battery according to an embodiment.

FIG. 2 is a longitudinal cross-sectional view illustrating the formation of a lithium metal layer in the solid rechargeable battery according to the embodiment.

FIG. 3 is a front view of an isostatic pressing device for an all solid rechargeable battery according to a first embodiment of the present disclosure.

FIG. 4 is a longitudinal cross-sectional view of FIG. 3.

FIG. 5 is a perspective view of a cover that opens and closes an inlet or an outlet of the vessel in the isostatic pressing device of FIGS. 3 and 4.

FIG. 6 is a cross-sectional perspective view of FIG. 5.

FIG. 7 is a cross-sectional view of FIG. 5.

FIG. 8 is a perspective view of a cover that opens and closes an inlet or and outlet of a vessel in the isostatic pressing device for an all solid rechargeable battery according to a second embodiment of the present disclosure.

FIG. 9 is a cross-sectional perspective view of FIG. 8.

FIG. 10 is a cross-sectional view of FIG. 8.

FIG. 11 is a perspective view of a cover that opens and closes an inlet or and outlet of a vessel in the isostatic pressing device for an all solid rechargeable battery according to a third embodiment of the present disclosure.

FIG. 12 is a cross-sectional perspective view of FIG. 11.

FIG. 13 is a cross-sectional view of FIG. 11.

FIG. 14 is a diagram illustrating a state in which the vessel of the isostatic pressing device for an all solid rechargeable battery according to the first embodiment of the present disclosure is opened and moves to an extraction or injection point.

FIG. 15 is a diagram illustrating a state in which the vessel of the isostatic pressing device moves to a pressed position, following FIG. 14.

FIG. 16 is a cross-sectional view illustrating a state in which the interference between the inlet or outlet of a vessel and the thermocouple of the cover is reduced or prevented in the process of FIG. 15.

FIG. 17 is a diagram illustrating a state in which the inlet or outlet of the vessel of the isostatic pressing device is closed with a cover, following the process of FIG. 15.

FIG. 18 is a pressed standby state diagram in which a block is inserted between a yoke and the cover of the isostatic pressing device, following the process of FIG. 17.

### DETAILED DESCRIPTION

Hereinafter, exemplary embodiments of the present invention will be described in detail with reference to the accompanying drawings so that those skilled in the art may easily practice the present invention. As those skilled in the art would realize, the described embodiments may be modified in various different ways, all without departing from the spirit or scope of the present invention.

In addition, unless explicitly described to the contrary, the word “comprise”, and variations such as “comprises” or “comprising”, will be understood to imply the inclusion of stated elements but not the exclusion of any other elements.

In the drawings, a thickness is enlarged to clearly express various layers and areas, and similar reference numerals are given to similar parts throughout the specification. It will be understood that when an element such as a layer, a film, a region, or a substrate is referred to as being “above” or “on” another element, it may be directly on another element or may have an intervening element present therebetween. In contrast, when an element is referred to as being “directly on” another element, there are no intervening elements present.

Also, here, “layer” includes not only the shape formed on the entire surface when observed in plan view, but also the shape formed on some surfaces. Here, “or” is not interpreted in an exclusive sense, and for example, “A or B” is interpreted as including A, B, A+B, etc.

### Cathode for all Solid Rechargeable Battery

An embodiment relates to a cathode for an all solid rechargeable battery that includes at least one of a current collector and a cathode active material layer located on the current collector, in which the cathode active material layer includes a cathode active material, a sulfide-based solid electrolyte, a binder, and a conductive material. However, the present disclosure is not limited thereto, and the cathode for an all solid rechargeable battery may include more or fewer components than the components described above.

In an exemplary embodiment, the cathode for the all solid rechargeable battery is manufactured by applying a cathode composition containing at least one of a cathode active material, a sulfide-based solid electrolyte, a binder, and a conductive material to a current collector, followed by drying and rolling the cathode composition.

### Cathode Active Material

Any cathode active material can be applied without limitation. For example, any commonly used cathode active material can be used in the all solid rechargeable battery. For example, the cathode active material may be a compound capable of reversible intercalation and deintercalation of lithium, and the cathode active material may include a compound expressed by any of the following chemical formulas.

LiₐA_{1-b}X_{b}D₂ (0.90≤a≤1.8, 0≤b≤0.5);

LiₐA_{1-b}X_{b}O_{2-c}D_{c} (0.90≤a≤1.8, 0≤b≤0.5, 0≤c≤0.05);

LiₐE_{1-b}X_{b}O_{2-c}D_{c} (0.90≤a≤1.8, 0≤b≤0.5, 0≤c≤0.05);

LiₐE_{2-b}X_{b}O_{4-c}D_{c} (0.90≤a≤1.8, 0≤b≤0.5, 0≤c≤0.05);

LiₐNi_{1-b-c}CO_{b}X_{c}D_{α} (0.90≤a≤1.8, 0≤b≤0.5, 0≤c≤0.5, 0<α≤2);

LiₐNi_{1-b-c}Co_{b}X_{c}O_{2-α}T_{α} (0.90≤a≤1.8, 0≤b≤0.5, 0≤c≤0.05, 0<+<2);

LiₐNi_{1-b-c}Co_{b}X_{c}O_{2-α}T₂ (0.90≤a≤1.8, 0≤b≤0.5, 0≤c≤0.05, 0<α<2);

LiₐNi_{1-b-c}Mn_{b}X_{c}D_{α} (0.90<a≤1.8, 0≤b≤0.5, 0≤c≤0.05, 0<α≤2);

LiₐNi_{1-b-c}Mn_{b}X_{c}O_{2-α}T_{α} (0.90≤a≤1.8, 0≤b≤0.5, 0≤c≤0.05, 0<α<2);

LiₐNi_{1-b-c}Mn_{b}X_{c}O_{2-α}T₂ (0.90≤a≤1.8, 0≤b≤0.5, 0≤c≤0.05, 0<+<2);

LiₐNi_{b}E_{c}G_{d}O₂ (0.90≤a≤1.8, 0≤b≤0.9, 0≤c≤0.5, 0.001≤d≤0.1);

LiₐNi_{b}Co_{c}Mn_{d}GₑO₂ (0.90≤a≤1.8, 0≤b≤0.9, 0≤c≤0.5, 0≤d≤0.5, 0.001≤e≤0.1);

LiₐNiG_{b}O₂ (0.90≤a≤1.8, 0.001≤b≤0.1);

LiₐCoG_{b}O₂ (0.90≤a≤1.8, 0.001≤b≤0.1);

LiₐMn_{1-b}G_{b}O₂ (0.90≤a≤1.8, 0.001≤b≤0.1);

LiₐMn₂G_{b}O₄ (0.90≤a≤1.8, 0.001≤b≤0.1);

LiₐMn_{1-g}G_{g}PO₄ (0.90≤a≤1.8, 0≤g≤0.5);

QO₂; QS₂; LiQS₂;

V₂O₅; LiV₂O₅;

LiZO₂;

LiNiVO₄;

Li_{(3-f)}J₂PO₄₃ (0≤f≤2);

Li_{(3-f)}Fe₂PO₄₃ (0≤f≤2);

LiₐFePO₄ (0.90≤a≤1.8).

In the above formulas, A is selected from the group consisting of Ni, Co, Mn, and combinations thereof, X is selected from the group consisting of Al, Ni, Co, Mn, Cr, Fe, Mg, Sr, V, rare earth elements, and combinations thereof; D is selected from the group consisting of O, F, S, P, and combinations thereof; E is selected from the group consisting of Co, Mn, and combinations thereof; T is selected from the group consisting of F, S, P, and combinations thereof; G is selected from the group consisting of Al, Cr, Mn, Fe, Mg, La, Ce, Sr, V, and combinations thereof; Q is selected from the group consisting of Ti, Mo, Mn, and combinations thereof; Z is selected from the group consisting of Cr, V, Fe, Sc, Y, and combinations thereof; and J is selected from the group consisting of V, Cr, Mn, Co, Ni, Cu, and combinations thereof.

The cathode active material may contain, for example, lithium cobalt oxide (LCO), lithium nickel oxide (LNO), lithium nickel cobalt oxide (NC), lithium nickel cobalt aluminum oxide (NCA), lithium nickel cobalt manganese oxide (NCM), lithium nickel manganese oxide (NM), lithium manganese oxide (LMO), lithium iron phosphate (LFP), or the like.

The cathode active material may contain lithium nickel-based oxide expressed by Chemical Formula 1 below, lithium cobalt-based oxide expressed by Chemical Formula 2 below, lithium iron phosphate-based compound expressed by Chemical Formula 3 below, or combinations thereof.

Liₐ₁Niₓ₁M¹_{y1}M²_{1-x1-y1}O₂ [Chemical Formula 1]

In the above Chemical Formula 1, 0.9≤a1≤1.8, 0.3≤x1≤1, 0≤y1≤0.7, and M¹ and M² are each independently one or more elements selected from the group consisting of Al, B, Ba, Ca, Ce, Co, Cr, Cu, F, Fe, Mg, Mn, Mo, Nb, P, S, Si, Sr, Ti, V, W, and Zr.

Liₐ₂Coₓ₂M³₁₋ₓ₂O₂ [Chemical Formula 2]

In the above Chemical Formula 2, 0.9≤a2≤1.8, 0.6≤x2≤1, and M³ is one or more elements selected from the group consisting of Al, B, Ba, Ca, Ce, Co, Cr, Cu, F, Fe, Mg, Mn, Mo, Nb, P, S, Si, Sr, Ti, V, W, and Zr.

Liₐ₃Feₓ₃M⁴₁₋ₓ₃PO₄ [Chemical Formula 3]

In the above Chemical Formula 3, 0.9≤a3≤1.8, 0.6≤x3≤1, and M⁴ is one or more elements selected from the group consisting of Al, B, Ba, Ca, Ce, Co, Cr, Cu, F, Fe, Mg, Mn, Mo, Nb, P, S, Si, Sr, Ti, V, W, and Zr.

An average particle diameter D50 of the cathode active material may be 1 μm to 25 μm and may be, for example, 3 μm to 25 μm, 5 μm to 25 μm, 5 μm to 20 μm, 8 μm to 20 μm, or 10 μm to 18 μm. The cathode active material with this particle size range may be harmoniously mixed with other components within the cathode active material layer and may implement the high capacity and high energy density.

The cathode active material may be in the form of secondary particles made by agglomerating a plurality of primary particles, or may be in the form of single particles. In addition, the cathode active material may be a spherical shape or a shape close to a spherical shape, or may be polyhedral or amorphous.

### Sulfide-Based Solid Electrolyte

The sulfide-based solid electrolyte may contain, for example, Li₂S—P₂S₅, Li₂S—P₂S₅—LiX (where X is a halogen element, for example I, or CI), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each independently an integer, and Z is Ge, Zn or Ga), Li₂S—GeS₂, Li₂S—SiS₂—Li₃PO₄, Li₂S—SiS₂-LiₚMO_{q} (where p and q are each independently an integer, and M is P, Si, Ge, B, Al, Ga or In), or a combination thereof.

Such a sulfide-based solid electrolyte may be obtained by mixing, for example, Li₂S and P₂S₅ at a molar ratio of 50:50 to 90:10 or a molar ratio of 50:50 to 80:20, and optionally heat-treating the mixture. Within the above mixing ratio range, the sulfide-based solid electrolyte having excellent ionic conductivity may be manufactured. The ion conductivity may be further improved by adding SiS₂, GeS₂, B₂S₃, etc., as other components.

A mechanical milling or solution method may be applied as a method of mixing sulfur-containing raw materials to prepare the sulfide-based solid electrolyte. The mechanical milling is a method of particulating and mixing starting materials by putting the starting materials, a ball mill, etc., in a reactor and stirring the mixture. When using the solution method, the solid electrolyte may be obtained as a precipitate by mixing the starting materials in a solvent. In addition, when heat treatment is performed after mixing, the crystals of the solid electrolyte may become more robust and the ionic conductivity may be improved. As an example, the sulfide-based solid electrolyte may be prepared by mixing sulfur-containing raw materials and heat-treating the sulfur-containing raw materials two or more times. In this case, the sulfide-based solid electrolyte having high ionic conductivity and robustness may be prepared.

As an example, the sulfide-based solid electrolyte particles may contain argyrodite-type sulfide. The azirodite-type sulfide may be expressed by, for example, LiₐM_{b}P_{c}S_{d}Aₑ (where a, b, c, d, and e each independently range from 0 to 12, M is a combination of multiple metals other than metal or Li, and A is F, Cl, Br, or I), and as a specific example, may be expressed by the chemical formula of Li₇₋ₓPS₆₋ₓAₓ (where x ranges from 0.2 to 1.8, and A is F, Cl, Br, or I). The azirodite-type sulfide may be, for example, Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, etc.

The sulfide-based solid electrolyte particles containing such azirodite-type sulfide may have high ionic conductivity, e.g., ranging from 10⁻⁴ S/cm to 10⁻² S/cm, which is an ionic conductivity of a typical liquid electrolyte at room temperature. The sulfide-based solid electrolyte particles containing such azirodite-type sulfide may form a tight bond between the cathode active material and the solid electrolyte without causing a decrease in the ion conductivity, and may further form a tight interface between the electrode layer and the solid electrolyte layer. The solid rechargeable battery containing the sulfide-based solid electrolyte particles containing such azirodite-type sulfide may improve the performance of the battery such as rate characteristics, coulombic efficiency, and lifespan characteristics.

The ajirodite-type sulfide-based solid electrolyte may be prepared by, for example, mixing lithium sulfide, phosphorus sulfide, and optionally lithium halide. After mixing them, a heat treatment may be performed. The heat treatment may include, for example, two or more heat treatment steps.

The average particle diameter D50 of the sulfide-based solid electrolyte particles according to an embodiment may be 5.0 μm or less and may be, for example, 0.1 μm to 5.0 μm, 0.1 μm to 4.0 μm, 0.1 μm to 3.0 μm, 0.5 μm to 2.0 μm, or 0.1 μm to 1.5 μm. Alternatively, the sulfide-based solid electrolyte particles may be small particles having the average particle diameter D50 of 0.1 μm to 1.0 μm depending on the location or purpose of use, or may be large particles having an average particle diameter D50 of 1.5 μm to 5.0 μm. The sulfide-based solid electrolyte particles in this particle size range may effectively penetrate between the solid particles in the battery, and may have excellent contact with the electrode active material and the connectivity between the solid electrolyte particles. The average particle diameter of the sulfide-based solid electrolyte particles may be measured using a microscope image. For example, the particle size distribution may be obtained by measuring the size of about 20 particles in a scanning electron microscope image, and the D50 may be calculated from the particle size distribution.

The content of the all solid electrolyte in the cathode for the all solid rechargeable battery may be 0.5 wt % to 35 wt % and may be, for example, 1 wt % to 35 wt %, 5 wt % to 30 wt %, and 8 wt % to 25 wt %, or 10 wt % to 20 wt %. This is the content relative to the total weight of the components in the cathode, and in some embodiments, may be the content relative to the total weight of the cathode active material layer.

In an embodiment, the cathode active material layer contains 50% to 99.35 wt % of the cathode active material, 0.5% to 35 wt % of the sulfide-based solid electrolyte, and 0.1% to 10 wt % of fluorinated resin binder, and 0.05 wt % to 5 wt % of the vanadium oxide, based on 100 wt % of the cathode active material layer. When this content range is satisfied, the cathode for an all solid rechargeable battery can maintain a high adhesion while maintaining a high capacity and high ionic conductivity, and can maintain a viscosity of the cathode composition at an appropriate level, thereby improving the processability.

### Binder

The binder helps the cathode active material particles adhere to each other and also helps the cathode active material adhere to the current collector, and representative examples of the binder may include polymers containing polyvinylalcohol, carboxymethylcellulose, hydroxypropylcellulose, diacetylcellulose, diacetylcellulose, polyvinylchloride, carboxylated polyvinylchloride, polyvinyl fluoride, and ethylene oxide, polyvinylpyrrolidone, polyurethane, polytetrafluoroethylene, polyvinylidene fluoride, polyethylene, polypropylene, styrene butadiene rubber, acrylated styrene butadiene rubber, epoxy resin, nylon, etc., but are not limited thereto.

### Conductive Material

The cathode active material layer may further contain a conductive material. The conductive material is used to impart the conductivity to the electrode, and may contain, for example, carbon-based materials such as natural graphite, artificial graphite, carbon black, acetylene black, Ketjen black, carbon fiber, and carbon nanotubes; metallic materials containing copper, nickel, aluminum, silver, etc., and having the form of metal powder or metal fiber; a conductive polymer such as polyphenylene derivative; or a combination thereof.

The conductive material may be contained in an amount of 0.1 wt % to 5 wt % or 0.1 wt % to 3 wt %, based on the total weight of each component of the cathode for the all solid rechargeable battery or based on the total weight of the cathode active material layer. Within the above content range, the conductive material may improve the electrical conductivity without deteriorating the performance of the battery.

When the cathode active material layer further contains the conductive material, the cathode active material layer contains 45% to 99.25 wt % of cathode active material and 0.5% to 35 wt % of sulfide-based solid electrolyte, 0.1 wt % to 10 wt % of fluorine resin binder, 0.05 wt % to 5 wt % of vanadium oxide, and 0.1 wt % to 5 wt % of conductive material, based on 100 wt % of cathode active material layer.

The cathode for the lithium secondary battery may further contain an oxide-based inorganic solid electrolyte in addition to the solid electrolyte described above. The oxide-based inorganic solid electrolyte may contain, for example, Li₁₊ₓTi₂₋ₓAl PO₄₃ (LTAP) (0≤x≤₄), Li_{1+x+y}AlₓTi₂₋ₓSi_{y}P_{3-y}O₁₂ (0<x<2, 0≤y<3), BaTiO₃, Pb(Zr,Ti)O₃(PZT), Pb₁₋ₓLaₓZr_{1-y}Ti_{y}O₃(PLZT) (0≤x<1, 0≤y<1), PB (Mg₃Nb_{2/3})O₃—PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithiumphosphate (Li₃PO₄), lithiumtitaniumphosphate(LiₓTi_{y} PO₄₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithiumlanthanumtitanate (LiₓLa_{y}TiO₃, 0<x<2, 0<y<3), Li₂O, LiAlO₂, Li₂O—Al₂O₃—SiO₂—P₂O₅—TiO₂—GeO₂-based ceramics, Garnet-based ceramics Li₃₊ₓLa₃M₂O₁₂ (M=Te, Nb, or Zr; x is an integer ranging from 1 to 10).

### All Solid Rechargeable Battery

An embodiment provides the all solid rechargeable battery including the above-described cathode and anode, and the solid electrolyte layer located between the cathode and the anode. The all solid rechargeable battery may be an all solid rechargeable battery or an all solid lithium rechargeable battery.

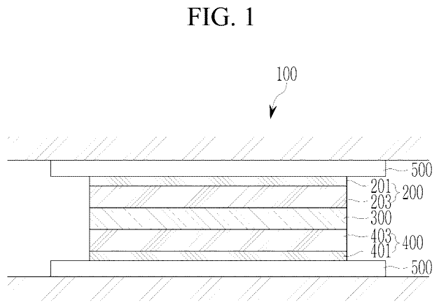

FIG. 1 is a cross-sectional view illustrating an all solid rechargeable battery according to an embodiment. Referring to FIG. 1, an all solid rechargeable battery 100 may have a structure in which an electrode assembly in which an anode 400 including an anode current collector 401 and an anode active material layer 403, a solid electrolyte layer 300, and a cathode 200 including a cathode active material layer 203 and a cathode current collector 201 are stacked is received in a case such as a pouch. The all solid rechargeable battery 100 may further include an elastic layer 500 outside at least one of the cathode 200 or the anode 400. Although FIG. 1 illustrates one electrode assembly including the anode 400, the solid electrolyte layer 300, and the cathode 200, the all solid rechargeable battery may also be manufactured by stacking two or more electrode assemblies.

### Anode

An anode for an all solid rechargeable battery may include, for example, a current collector and an anode active material layer located on the current collector. The anode active material layer may contain an anode active material and may further contain a binder, a conductive material, and/or a solid electrolyte.

The anode active material contains a material capable of reversibly intercalating/deintercalating lithium ions, lithium metal, an alloy of lithium metal, a material capable of doping and dedoping lithium, or a transition metal oxide.

The material capable of reversibly intercalating/deintercalating lithium ions may be a carbon-based anode active material, and may contain, for example, crystalline carbon, amorphous carbon, or a combination thereof. Examples of the crystalline carbon contain graphite such as amorphous, plate-shaped, flake, spherical or fibrous natural graphite or artificial graphite, and examples of the amorphous carbon may contain soft carbon or hard carbon, and mesophase pitch carbide, fired coke, etc.

The alloy of lithium metal may contain an alloy of lithium and one or more metal selected from the group consisting of Na, K, Rb, Cs, Fr, Be, Mg, Ca, Sr, Si, Sb, Pb, In, Zn, Ba, Ra, Ge, Al, and Sn.

As a material that may be doped and dedoped in lithium, the Si-based anode active material or the Sn-based anode active material may be used, in which, as the Si-based anode active material, silicon, silicon-carbon composite, SiOₓ (0<x<2), and Si-Q alloy (the Q is an element selected from the group consisting of alkali metals, alkaline earth metals, Group 13 elements, Group 14 elements, Group 15 elements, Group 16 elements, transition metals, rare earth elements, and combinations thereof, but not Si) may be used, and as the Sn-based anode active material, Sn, SnO₂, and Sn—R alloy (the R is an element selected from the group consisting of alkali metals, alkaline earth metals, Group 13 elements, Group 14 elements, Group 15 elements, Group 16 elements, transition metals, rare earth elements, and combinations thereof, but not Sn) may be used, and in addition, a mixture of at least one of them and SiO₂ may also be used. As the elements Q and R, elements selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and combinations thereof may be used.

For example, the silicon-carbon composite may be a silicon-carbon composite including a core containing crystalline carbon and silicon particles and an amorphous carbon coating layer located on the surface of the core. The crystalline carbon may be artificial graphite, natural graphite, or a combination thereof. As an amorphous carbon precursor, coal-based pitch, mesophase pitch, petroleum-based pitch, coal-based oil, petroleum-based heavy oil, or a polymer resin such as phenol resin, furan resin, and polyimide resin may be used. In this case, the content of silicon may be 10 wt % to 50 wt % based on the total weight of the silicon-carbon composite. In addition, the content of the crystalline carbon may be 10 wt % to 70 wt % based on the total weight of the silicon-carbon composite, and the content of the amorphous carbon may be 20 wt % to 40 wt % based on the total weight of the silicon-carbon composite. In addition, the thickness of the amorphous carbon coating layer may be 5 nm to 100 nm.

The average particle diameter D50 of the silicon particles may be 10 nm to 20 μm and may be, for example, 10 nm to 500 nm. The silicon particles may exist in an oxidized form, and in this case, the atomic content ratio of Si:O in the silicon particles, which indicates the degree of oxidation, may be 99:1 to 33:67. The silicon particles may be SiOₓ particles, and in this case, the x in SiOₓ may range from 0 to 2. Here, the average particle diameter D50 is measured with a particle size analyzer using a laser diffraction method and means the diameter of particles with a cumulative volume of 50 vol % in the particle size distribution.

The Si-based anode active material or Sn-based anode active material may be used by mixing with the carbon-based anode active material. The mixing ratio of the Si-based anode active material or Sn-based anode active material and the carbon-based anode active material may be 1:99 to 90:10 in weight ratio.

The content of the anode active material in the anode active material layer may be 95 wt % to 99 wt % based on the total weight of the anode active material layer.

In an embodiment, the anode active material layer further contains a binder and may optionally further contain a conductive material. The content of the binder in the anode active material layer may be 1 wt % to 5 wt % based on the total weight of the anode active material layer. In addition, when the conductive material is further contained, the anode active material layer may contain 90% to 98 wt % of anode active material, 1% to 5 wt % of binder, and 1% to 5 wt % of conductive material.

The binder serves to adhere the anode active material particles to each other and also to adhere the anode active material to the current collector. The binder may contain a water-insoluble binder, a water-soluble binder, or a combination thereof.

The water-insoluble binder may contain, for example, polyvinyl chloride, carboxylated polyvinyl chloride, polyvinyl fluoride, polymers containing ethylene oxide, ethylene propylene copolymer, polystyrene, polyvinylpyrrolidone, polyurethane, polytetrafluoroethylene, polyvinylidene fluoride, polyethylene, polypropylene, polyamideimide, polyimide, or a combination thereof.

The water-soluble binder may contain a rubber-based binder or a polymer resin binder. The rubber-based binder may be selected from styrene-butadiene rubber, acrylated styrene-butadiene rubber, acrylonitrile-butadiene rubber, acrylic rubber, butyl rubber, fluorine rubber, and a combination thereof. The polymer resin binder may be one selected from the group consisting of polyethylene oxide, polyvinylpyrrolidone, polyepichlorohydrin, polyphosphazene, polyacrylonitrile, ethylene propylene diene copolymer, polyvinylpyridine, chlorosulfonated polyethylene, latex, polyester resin, acryl resin, phenol resin, epoxy resin, polyvinylalcohol, and a combination thereof.

When the water-soluble binder is used as the anode binder, a thickener capable of imparting viscosity may be used together, and the thickener may contain, for example, a cellulose-based compound. The cellulose-based compound may contain carboxymethyl cellulose, hydroxypropylmethyl cellulose, methyl cellulose, alkali metal salts thereof, or a combination thereof. Na, K, or Li may be used as the alkali metal. The amount of thickener used may be 0.1 to 3 parts by weight based on 100 parts by weight of the anode active material.

The conductive material is used to provide the conductivity to the electrode, and may contain, for example, carbon-based materials such as natural graphite, artificial graphite, carbon black, acetylene black, Ketjen black, carbon fiber, and carbon nanotubes; metallic materials containing copper, nickel, aluminum, silver, etc., and having the form of metal powder or metal fiber; a conductive polymer such as polyphenylene derivative; or a mixture thereof.

The anode current collector may be selected from copper foil, nickel foil, stainless steel foil, titanium foil, nickel foam, copper foam, a polymer substrate coated with a conductive metal, and a combination thereof.

As another example, the anode for the all solid rechargeable battery may be a precipitated anode. The precipitated anode refers to an anode that does not contain the anode active material during the battery assembly, but that has lithium metal, etc., precipitated when the battery is charged and acting as the anode active material.

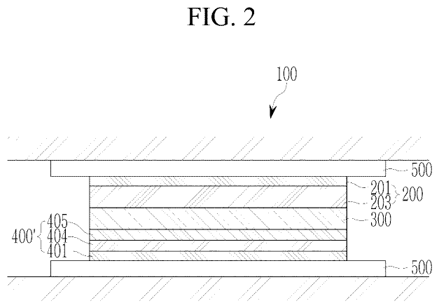

FIG. 2 is a schematic cross-sectional view of an all solid rechargeable battery including a precipitated anode according to an embodiment. Referring to FIG. 2, a precipitated anode 400′ may include a current collector 401 and an anode coating layer 405 located on the current collector. In the all solid rechargeable battery having such a precipitated anode 400′, the initial charge starts while the anode active material is not present, and high-density lithium metal, etc., are precipitated between the current collector 401 and the anode coating layer 405 during the charge to form the lithium metal layer 404, which may serve as the anode active material. Accordingly, in the all sold rechargeable battery that has been charged at least once, the precipitated anode 400′ may include a current collector 401, a lithium metal layer 404 located on the current collector, and an anode coating layer 405 located on the metal layer. The lithium metal layer 404 refers to a layer in which the lithium metal, etc., are precipitated during the charge of the battery, and may be referred to as a metal layer, an anode active material layer, or etc.

The anode coating layer 405 may contain metal, carbon material, or a combination thereof that serves as a catalyst.

The metal may contain, for example, gold, platinum, palladium, silicon, silver, aluminum, bismuth, tin, zinc, or a combination thereof, and may be composed of one of these or several types of alloys. When the metal exists in the particle form, the average particle diameter D50 of the metal may be about 4 μm or less and may be, for example, 10 nm to 4 μm.

The carbon material may contain, for example, crystalline carbon, amorphous carbon, or a combination thereof. The crystalline carbon may contain, for example, natural graphite, artificial graphite, mesophase carbon microbeads, or a combination thereof. The amorphous carbon may contain, for example, carbon black, activated carbon, acetylene black, denka black, Ketjen black, or a combination thereof.

When the anode coating layer 405 contains both the metal and the carbon material, the mixing ratio of the metal and the carbon material may be, for example, a weight ratio of 1:10 to 2:1. In this case, the precipitation of the lithium metal may be effectively promoted and the characteristics of the all state rechargeable battery may be improved. The anode coating layer 405 may contain, for example, a carbon material on which a catalyst metal is supported, or may contain a mixture of metal particles and carbon material particles.

For example, the anode coating layer 405 may contain the metal and the amorphous carbon, and in this case, the precipitation of the lithium metal may be effectively promoted.

The anode coating layer 405 may further contain a binder, and the binder may be a conductive binder. In addition, the anode coating layer 405 may further contain a filler, a dispersant, an ion conductive material, etc., which are general additives.

The thickness of the anode coating layer 405 may be, for example, 100 nm to 20 μm, 500 nm to 10 μm, or 1 μm to 5 μm.

The precipitated anode 400′ may further include a thin film on the surface of the current collector, that is, between the current collector and the anode coating layer. The thin film may contain an element that may form an alloy with lithium. Elements that may form an alloy with lithium may be, for example, gold, silver, zinc, tin, indium, silicon, aluminum, bismuth, etc., and may be composed of one type or several types of alloys. The thin film may further flatten the precipitation form of the lithium metal layer 404 and further improve the characteristics of the all solid rechargeable battery. The thin film may be formed by, for example, vacuum deposition, sputtering, plating methods, or the like. The thickness of the thin film may be, for example, 1 nm to 500 nm.

### Solid Electrolyte Layer

The solid electrolyte layer 300 may contain a sulfide-based solid electrolyte, an oxide-based solid electrolyte, etc. The specific details of the sulfide-based solid electrolyte and the oxide-based solid electrolyte are as described above.

In an example, the solid electrolyte contained in the cathode 200 and the solid electrolyte contained in the solid electrolyte layer 300 may contain the same compound or different compounds. For example, when both the cathode 200 and the solid electrolyte layer 300 contain the ajirodite type sulfide-based solid electrolyte, the overall performance of the all solid rechargeable battery may be improved. In addition, as an example, when both the cathode 200 and the solid electrolyte layer 300 contain the coated solid electrolyte described above, the all solid rechargeable battery may implement excellent initial efficiency and lifespan characteristics while implementing the high capacity and high energy density.

Meanwhile, the average particle diameter D50 of the solid electrolyte contained in the cathode 200 may be smaller than the average particle diameter D50 of the solid electrolyte contained in the solid electrolyte layer 300. In this case, the overall performance may be improved by maximizing the energy density of the all solid rechargeable battery and increasing the mobility of lithium ions. For example, the average particle diameter D50 of the solid electrolyte contained in the cathode 200 may be 0.1 μm to 1.0 μm, or 0.1 μm to 0.8 μm, and the average particle diameter D50 of the solid electrolyte contained in the solid electrolyte layer 300 may be 1.5 μm to 5.0 μm, or 2.0 μm to 4.0 μm, or 2.5 μm to 3.5 μm. When this particle size range is satisfied, the energy density of the all solid rechargeable battery may be improved and the lithium ions are easily transferred to suppress resistance, thereby improving the overall performance of the all solid rechargeable battery. Here, the average particle diameter D50 of the solid electrolyte may be measured through the particle size analyzer using a laser diffraction method. Alternatively, the D50 value may be calculated by selecting about 20 particles from a microscope photo such as a scanning electron microscope, measuring the particle size, and obtaining the particle size distribution.

The solid electrolyte layer may further contain the binder in addition to the solid electrolyte. In this case, the binder may be styrene butadiene rubber, polytetrafluoroethylene, polyvinylidene fluoride, polyethylene, an acrylate-based polymer, or a combination thereof, but is not limited thereto, and anything used as a binder in the relevant technical field may be used. The acrylate-based polymer may be, for example, butyl acrylate, polyacrylate, polymethacrylate, or a combination thereof.

The solid electrolyte layer may be formed by adding the solid electrolyte to a binder solution, coating the solid electrolyte on a base film, and drying the solid electrolyte. The solvent for the binder solution may be isobutyryl isobutyrate, xylene, toluene, benzene, hexane, or a combination thereof. The process of forming the solid electrolyte layer is widely known in the field, and therefore, detailed description thereof will be omitted.

The thickness of the solid electrolyte layer may be, for example, 10 μm to 150 μm.

The solid electrolyte layer may further contain an alkali metal salt, and/or an ionic liquid, and/or a conductive polymer.

The alkali metal salt may be, for example, a lithium salt. The content of the lithium salt in the solid electrolyte layer may be 1M or more and may be, for example, 1M to 4M. In this case, the lithium salt may improve the ion conductivity by improving the lithium-ion mobility of the solid electrolyte layer.

The lithium salt may contain, for example, LiSCN, LiN(CN)₂, Li (CF₃SO₂)₃C, LiC₄F₉SO₃, LiN(SO₂CF₂CF₃)₂, LiCl, LiF, LiBr, LiI, LiB C₂O₄₂, LiBF₄, LiBF₃ C₂F₅, lithium bis(oxalato) borate (LiBOB), lithium oxalyldifluoroborate, (LIODFB), lithium difluoro (oxalato) borate, (LiDFOB), lithium bis(trifluoro methanesulfonyl)imide, LiTFSI, LiN (SO₂CF₃)₂, lithium bis(fluorosulfonyl)imide, LiFSI, LiN(SO₂F)₂, LiCF₃SO₃, LiAsF₆, LiSbF₆, LiClO₄ or a mixture thereof.

In addition, the lithium salt may be an imide-based lithium salt, and the imide-based lithium salt may contain, for example, lithium bis(trifluoro methanesulfonyl)imide (LiN (SO₂CF₃)₂), lithium bis(fluorosulfonyl)imide (LiFSI, LiN (SO₂F)₂). The lithium salt may maintain or improve the ionic conductivity by maintaining appropriate chemical reactivity with ionic liquid.

The ionic liquid has a melting point below room temperature, is in a liquid state at room temperature, and refers to a salt consisting of only ions or a room temperature molten salt.

The ionic liquid may be a compound containing a) one or more positive ions selected from the groups consisting of ammonium-based, pyrroleidinium-based, pyridinium-based, pyrimidinium-based, imidazole-based, piperidinium-based, pyrazole-based, oxazole-based, pyridazinium-based, phosphonium-based, sulfonium-based, triazole-based ionic liquids and a mixture thereof and b) one or more negative ions selected from the group consisting of BF₄—, PF₆—, AsF₆—, SbF₆—, AlCl₄—, HSO₄—, ClO₄—, CH₃SO₃—, CF₃CO₂—, Cl—, Br—, I—, BF₄—, SO₄—, CF₃SO₃—, FSO₂₂N—, (C₂F₅SO₂)₂N—, (C₂F₅SO₂, CF₃SO₂)N—, and (CF₃SO₂)₂N—.

The ionic liquid may contain, for example, one or more selected from the group consisting of N-methyl-N-propylpyrrolidinium bis(trifluoromethanesulfonyl) imide N-butyl-N-methylpyrrolidium bis(3-trifluoromethylsulfonyl) imide, 1-butyl-3-methylimidazolium bis(trifluoromethylsulfonyl)amide, and 1-ethyl-3-methylimidazolium bis(trifluoromethylsulfonyl)amide.

The weight ratio of the solid electrolyte and the ionic liquid in the solid electrolyte layer may be 0.1:99.9 to 90:10 such as, for example, 10:90 to 90:10, 20:80 to 90:10, 30:70 to 90:10, 40:60 to 90:10, or 50:50 to 90:10. The solid electrolyte layer that satisfies the above range may maintain or improve the ionic conductivity by improving the electrochemical contact area with the electrode. Accordingly, it is possible to improve the energy density, the discharge capacity, the rate characteristics, etc., of the all solid rechargeable battery.

The all solid rechargeable battery may be a unit cell having a structure of cathode/solid electrolyte layer/anode, a bicell having a structure of cathode/solid electrolyte layer/anode/solid electrolyte layer/cathode, or a stacked battery in which the structure of the unit cell is repeated.

The shape of the all solid rechargeable battery is not particularly limited, and may contain, for example, a coin shape, a button shape, a sheet shape, a stack shape, a cylindrical shape, a flat shape, etc. In addition, the all solid rechargeable battery may also be applied to large batteries used in electric vehicles, etc. For example, the all solid rechargeable battery may also be used in a hybrid vehicle such as a plug-in hybrid electric vehicle (PHEV). In addition, the all solid rechargeable battery may be used in fields that require large amounts of power storage, and may be used in, for example, an electric bicycle, a power tool, etc.

As described above, the all solid rechargeable battery may be based on the sulfide-based electrolyte, and the anode, the solid electrolyte, and the cathode may be densified under ultra-high pressure heating conditions (for example, 500 MPa, at 90° C. to 100° C.) through the isostatic pressing device for the all solid rechargeable battery.

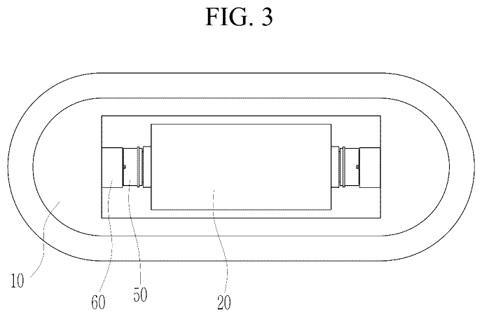

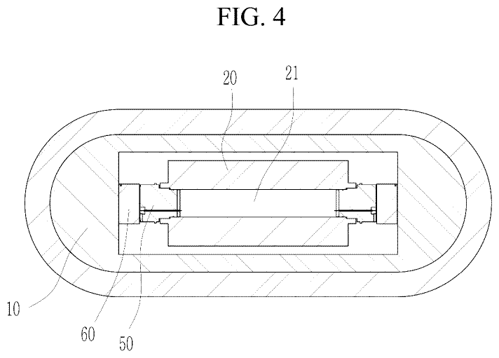

FIG. 3 is a front view of an isostatic pressing device for an all solid rechargeable battery according to the first embodiment of the present disclosure. FIG. 4 is a longitudinal cross-sectional view of FIG. 3. Referring to FIGS. 3 and 4, the isostatic pressing device is used to densify the solid electrolyte.

The isostatic pressing device of the first embodiment includes a yoke 10 forming the overall outer frame, a vessel 20, which is a high-pressure container input into or extracted from the yoke 10, a thermocouple 40 for measuring and monitoring a temperature level of the pressed medium inside the vessel 20, and a cover 50 for opening and closing an inlet and an outlet provided on both sides of the vessel 20 in the axial direction.

The vessel 20 is installed inside the yoke 10 and enables the densification of the solid electrolyte by isostatically pressing the all solid rechargeable battery. The yoke 10 is inserted into an internal space 21 of the vessel 20. Since the thermocouple 40 may not be installed in the vessel 20, the thermocouple 40 may be installed in the cover 50. As an example, the vessel 20 may be formed in a cylinder.

For example, the isostatic pressing device of the first embodiment may be configured to generate high pressure to densify the solid electrolyte for the all solid rechargeable battery at 100 MPa to 700 MPa. FIGS. 3 and 4 illustrate a cold isostatic pressing (CIP).

Liquids such as water or oil may be used as a pressured medium. In this case, a low temperature environment of less than 300° C. can be used for the cold isostatic pressing (CIP). In some embodiments, a hot isostatic pressing (HIP) is used having a high temperature environment with a temperature higher than or equal to 300° C. In this case, gas may be used as the pressed medium.

The cover 50 includes a high-pressure valve and pipe (not illustrated) for isostatic pressing, a low-pressure valve and pipe (not illustrated) for water supply and drainage, and a hole 51 for mounting the thermocouple 40. In addition, the cover 50 can repeat the operation of opening and closing the inlet and the outlet of the vessel 20.

The vessel 20 can repeat a transfer operation in a direction perpendicular to the concentric axis of the open covers 50 on both sides. For example, the cover 50 may be provided on the yoke 10 side to close and open the inlet and outlet of the vessel 20.

The thermocouple 40 can be installed in the hole 51 of the cover 50 to detect the temperature by contacting the pressed medium within the vessel 20. The thermocouple 40 can be configured so as not to interfere with or collide with each other during the opening and closing operation of the cover 50 and the transfer operation of the vessel 20. Additionally, the thermocouple can be configured so as not to be affected by the temperature of the cover 50 other than the pressed medium.

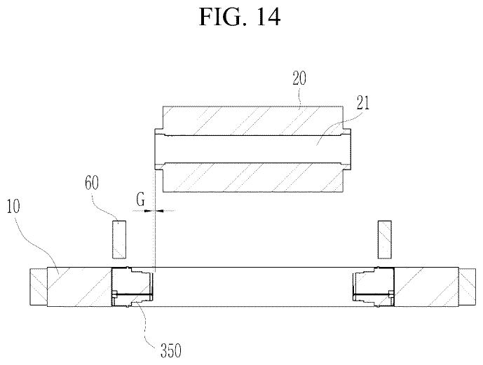

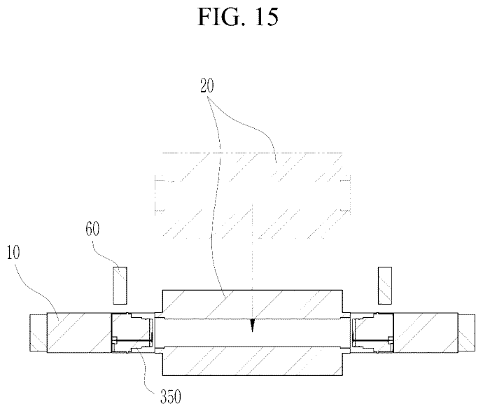

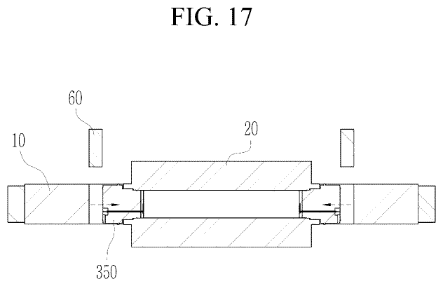

For example, in FIGS. 3 and 4, the vessel 20 is transported in the front-back direction to be transported to a post-ejection and insertion standby position (see FIG. 14) and a pressed position (see FIG. 15), and the cover 50 is transported in the left-right direction to be transported to the closed position (see FIG. 17) and the open position (see FIG. 14) with respect to the inlet and outlet of the vessel 20.

In addition, the isostatic pressing device can further include a block 60 inserted between the cover 50 and the yoke 10. By inserting the block 60 between the cover 50 and the yoke 10 while the inlet and outlet of the vessel 20 are closed with the cover 50, the cover 50 can firmly seal the inlet and outlet of vessel 20. For example, the vessel 20 is in a state that enables the internal pressing.

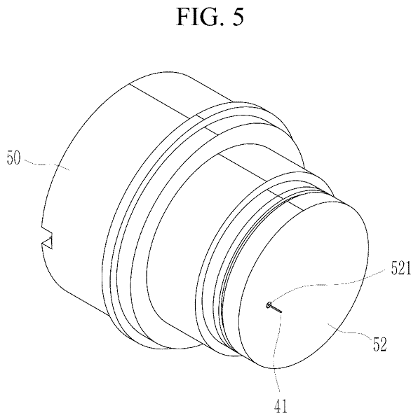

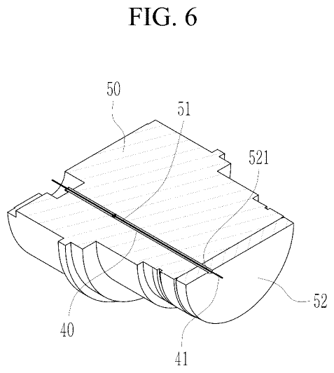

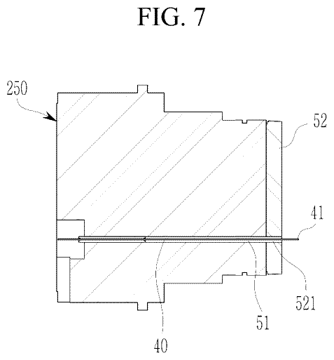

FIG. 5 is a perspective view of the cover that opens and closes the inlet or outlet of the vessel in the isostatic pressing device of FIGS. 3 and 4, FIG. 6 is a cross-sectional perspective view of FIG. 5, and FIG. 7 is a cross-sectional view of FIG. 5. Referring to FIGS. 5 to 7, the temperature measuring tip 41 of the thermocouple 40 protrudes from the hole 51 of the cover 50 to the inner surface of the cover 50 and is exposed to the pressed medium. For convenience, the description will be made with a drawing illustrating the front plate 52, but a configuration (not illustrated) in which the front plate 52 is integrated with the cover 50 will be described first.

The temperature measuring tip 41 of the thermocouple 40 can protrude shorter than the interval between the inner surface of the cover 50 and the vessel 20 when the vessel 20 moves to the pressed position (see FIG. 15). For example, the temperature measuring tip 41 may protrude 5 mm to 20 mm from the inner surface of the cover 50.

The length at which the temperature measuring tip 41 protrudes from the inner surface of the cover 50 may be configured such that interference with the vessel 20 does not occur. For example, in some embodiments, the closer the protrusion length is to 20 mm, the greater the contact with the pressed medium, thereby allowing a more accurate temperature measurement and monitoring. When the temperature measuring tip 41 protrudes on the surface of the front plate 52, interference with the vessel 20 may occur. As the protrusion length of the temperature measuring tip 41 approaches a value of 0 mm, interference and collision with the vessel 20 may be reduced, but the contact with the pressed medium may be reduced.

Therefore, the length of the temperature measuring tip 41 may be made as long as possible within a range that reduces or prevents interference between the cover 50 and the vessel 20 to increase the contact area with the pressed medium.

The configuration in which the front plate 52 is separate from the cover 50 will be described. The cover 50 further includes a front plate 52 formed on the inner surface thereof. The front plate 52 further forms an extension hole 521 extending from the hole 51. Since the front plate 52 may be coupled to the inner surface of the cover 50 in various structures, a detailed description of this structure is omitted.

The front plate 52 may be formed of a material different from the cover 50. The front plate 52 formed separately from the cover 50 facilitates processing of the cover 50, and the thermocouple 40 and the temperature measuring tip 41 are disposed in the extension hole 521 separated from the hole 51 of the cover 50.

Therefore, the temperature measuring tip 41 of the thermocouple 40 may be minimally affected by the cover 50 exposed to the external environment. The temperature measuring tip 41 of the thermocouple 40 accurately measures and monitors the temperature of the pressed medium inside the vessel 20.

The temperature measuring tip 41 of the thermocouple 40 protrudes from the extension hole 521 of the front plate 52 and may protrude 5 mm to 20 mm from the inner surface of the front plate 52. The length at which the temperature measuring tip 41 protrudes from the inner surface of the front plate 52 may be configured such that interference with the vessel 20 does not occur. For example, the closer the protrusion length is to 20 mm, the greater the contact with the pressed medium, thereby allowing more accurate temperature measurement and monitoring. When the temperature measuring tip 41 protrudes on the surface of the front plate 52, the interference with the vessel 20 may occur. As the protrusion length of the temperature measuring tip 41 approaches 0, interference and collision with the vessel 20 may be more effectively reduced, but the contact with the pressed medium may be reduced. In some embodiments, the stability of the isostatic pressing process may be secured.

Hereinafter, other embodiments will be described. Compared to the first embodiment, the description of the same configuration is omitted and the description of the different configuration is described.

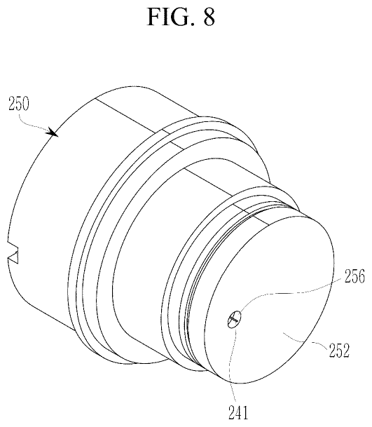

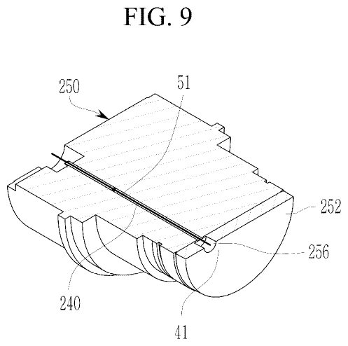

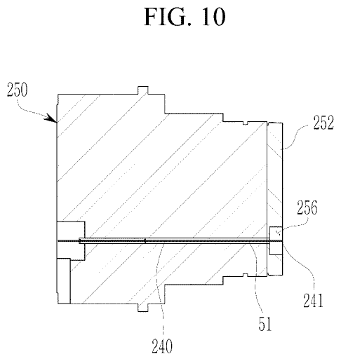

FIG. 8 is a perspective view of a cover that opens and closes an inlet or and outlet of a vessel in the isostatic pressing device for an all solid rechargeable battery according to a second embodiment of the present disclosure, FIG. 9 is a cross-sectional perspective view of FIG. 8, and FIG. 10 is a cross-sectional view of FIG. 8.

Referring to FIGS. 8 to 10, in the isostatic pressing device of the second embodiment, a cover 250 forms an expansion groove 256 having a diameter larger than the diameter of the hole 51 on the inner surface. For convenience, the description will be made with a drawing illustrating the front plate 252, but a configuration (not illustrated) in which the front plate 252 is integrated with the cover 250 will be described first.

In the thermocouple 240, the temperature measuring tip 241 protrudes from the expansion groove 256 to the inner surface of the cover 250 as much as possible and is exposed to the pressed medium. In some embodiments, the temperature measuring tip 241 does not protrude into the inner surface of the cover 250 and is disposed within the expansion groove 256 such that interference with the vessel 20 does not occur. The temperature measuring tip 241 has increased contact with the pressed medium positioned within the expansion groove 256, thereby more accurately measuring and monitoring the temperature.

The expansion groove may have a diameter of 5 mm to 20 mm and a depth of 5 mm to 20 mm. The diameter and depth allow the pressed medium to contact the temperature measuring tip 241 while reducing or preventing interference between the temperature measurement tip 241 and the vessel 20.

As the diameter and depth approach 20 mm, the contact between the temperature measuring tip 241 and the pressed medium may increase, thereby more accurately measuring and monitoring the temperature. The depth may be difficult to exceed 20 mm due to the structure of the cover 250. The closer the diameter and depth are to 5 mm, the shorter the length of the temperature measurement tip 241 is, and the smaller the diameter becomes, so a temperature measurement tab 241 may be affected by the cover 250, thereby lowering the accuracy of the temperature measurement.

Therefore, the diameter and depth of the expansion groove 256 may be configured to reduce or prevent interference between the temperature measuring tip 241 and the vessel 20 to increase the contact area with the pressed medium.

In some embodiments, the temperature measuring tip 241 may protrude shorter than the interval between the inner surface of the cover 250 and the vessel 20 while the vessel 20 moves to the pressed position. In this case, the temperature measuring tip 241 may be in contact with the pressed medium, thereby more accurately measuring and monitoring the temperature of the pressed medium.

A configuration in which the front plate 252 is separate from the cover 250 will be described. In some embodiments, the cover 250 further includes a front plate 252 formed on the inner surface thereof. The front plate 252 further forms the extension hole 256 extending from the hole 51. Since the front plate 252 may be coupled to the inner surface of the cover 50 in various structures, a detailed description of this structure is omitted.

The front plate 252 may be formed of a material different from the cover 250. The front plate 252 formed separately from the cover 250 facilitates the processing of the cover 250, and the thermocouple 240 and the temperature measuring tip 241 may be disposed in the expansion groove 256 separated from the hole 51 of the cover 250. The temperature measuring tip 241 may be spaced apart from the inner surface of the expansion groove 256 by a length equal to the radius of the expansion groove 256. The temperature measuring tip 241 protrudes from the inside of the expansion groove 256 of the front plate 252, and the protruding length thereof may be less than or equal to the maximum height of the expansion groove 256.

Therefore, the temperature measuring tip 241 of the thermocouple 240 may be minimally affected by the cover 250 exposed to the external environment. The temperature measuring tip 241 of the thermocouple 240 accurately measures and monitors the temperature of the pressed medium inside the vessel 20.

In the thermocouple 240, the temperature measuring tip 241 protrudes from the expansion groove 256 to the inner surface of the front plate 252 and is exposed to the pressed medium. In some embodiments where the temperature measuring tip 241 does not protrude into the inner surface of the front plate 252 and is disposed within the expansion groove 256, interference with the vessel 20 is reduced or prevented. In some embodiment, the temperature measuring tip 241 has increased contact with the pressed medium positioned within the expansion groove 256, thereby more accurately measuring and monitoring the temperature.

The expansion groove 256 of the front plate 252 may have a diameter of 5 mm to 20 mm and a depth of 5 mm to 20 mm. The diameter and depth of the front plate 252 allow the pressed medium to sufficiently contact the temperature measuring tip 241 while reducing or preventing the interference between the temperature measurement tip 241 and the vessel 20.

As the diameter and depth approach 20 mm, contact between the temperature measuring tip 241 and the pressed medium increases, thereby more accurately measuring and monitoring the temperature. The depth may be difficult to exceed 20 mm due to the structure of the front plate 252. As the diameter and depth approach 5 mm, the length of the temperature measurement tip 241 becomes shorter, which may lower the accuracy of temperature measurement, and as the diameter becomes smaller, the temperature measurement tab 241 may be affected by the front plate 252.

Therefore, the diameter and depth of the expansion groove 256 may be configured to reduce or prevent interference between the temperature measuring tip 241 and the vessel 20 to increase the contact area with the pressed medium.

In addition, the temperature measuring tip 241 may further protrude shorter than the interval between the inner surface of the front plate 252 of the cover 250 and the vessel 20 when the vessel 20 moves to the pressed position. For example, the temperature measuring tip 241 may be in contact with the pressed medium, thereby more accurately measuring and monitoring the temperature of the pressed medium.

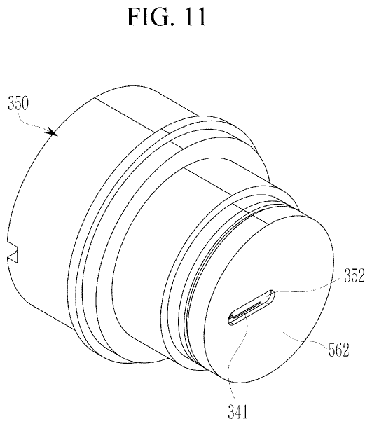

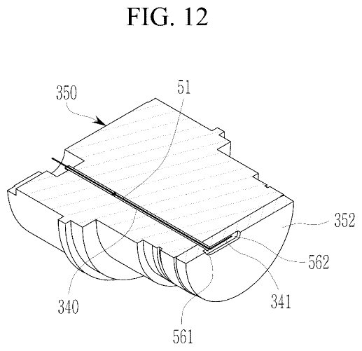

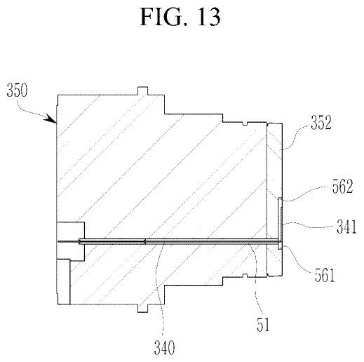

FIG. 11 is a perspective view of a cover that opens/closes an inlet or and outlet of a vessel in the isostatic pressing device for an all solid rechargeable battery according to a third embodiment of the present disclosure, FIG. 12 is a cross-sectional perspective view of FIG. 11, and FIG. 13 is a cross-sectional view of FIG. 11.

Referring to FIGS. 11 to 13, in the isostatic pressing device of the third embodiment, the cover 350 forms an expansion groove 561 on the inner surface to have a diameter larger than the diameter of the hole 51, and further includes an extension groove 562 connected to the expansion groove 561. For convenience, the description will be made with a drawing illustrating the front plate 352, but a configuration (not illustrated) in which the front plate 352 is integrated with the cover 350 will be described first.

In the thermocouple 340, the temperature measuring tip 341 protrudes from the expansion groove 561 and the extension groove 562 to the inner surface of the cover 350 and is exposed to the pressed medium. In some embodiments where the temperature measuring tip 341 does not protrude into the inner surface of the cover 350 and is disposed within the expansion groove 561 and the extension groove 562, interference with the vessel 20 may be reduced or prevented. The temperature measuring tip 341 has increased contact with the pressed medium positioned within the expansion groove 561 and the extension groove 562, thereby more accurately measuring and monitoring the temperature.

The temperature measuring tip 341 is bent at a right angle in the expansion groove 561 and disposed in the extension groove 562. In this case, the expansion groove 561 of the cover 350 may have a diameter of 5 mm to 20 mm and a depth of 5 mm to 20 mm, and the extension groove 562 may have a width of 5 mm to 20 mm. The diameter and depth of the extension groove 561 and the width of the extension groove 562 enable the pressed medium to contact the temperature measuring tip 341 while reducing or preventing interference between the temperature measurement tip 341 and the vessel 20.

As the diameter and depth of the expansion groove 561 and the width of the extension groove 562 approach 20 mm, contact with the temperature measuring tip 341 and the pressed medium may increase, thereby more accurately measuring and monitoring the temperature. The depth may be difficult to exceed 20 mm due to the structure of the cover 350. As the diameter and depth of the expansion groove 561 and the width of the extension groove 562 approach 5 mm, the interval between the temperature measuring tip 341 and the cover 350 decreases, so the temperature measuring tip 341 may be affected by the cover 350.

Therefore, the diameter and depth of the expansion groove 561 and the width of the extension groove 562 may be configured to reduce or prevent interference between the temperature measuring tip 341 and the vessel 20 to increase the contact area with the pressed medium.

In some embodiments, the temperature measuring tip 341 may protrude shorter than the interval between the inner surface of the cover 350 and the vessel 20 when the vessel 20 moves to the pressed position. In this case, the temperature measuring tip 341 is in contact with the pressed medium, thereby more accurately measuring and monitoring the temperature of the pressed medium.

The configuration in which the front plate 352 is separate from the cover 350 will be described. In some embodiments, the cover 350 further includes a front plate 352 formed on the inner surface thereof. The front plate 352 forms the expansion groove 561 extending from the hole 51 and further includes the extension groove 562 connected to the expansion groove 561. Since the front plate 352 may be coupled to the inner surface of the cover 350 in various structures, a detailed description of this structure is omitted.

The front plate 352 may be formed of a material different from the cover 350. The front plate 352 formed separately from the cover 350 facilitates the processing of the cover 350, and the thermocouple 340 and the temperature measuring tip 341 are disposed in the expansion groove 561 separated from the hole 51 of the cover 350 and the extension groove 562 connected to the expansion groove 561. The temperature measuring tip 341 may be spaced apart from the inner surface of the expansion groove 561 by a distance equal to the radius of the expansion groove 561, and may be spaced apart from the inner surface of the expansion groove 562 by a distance equal to ½ the width of the extension groove 562. As such, the temperature measuring tip 341 may protrude from the inside of the expansion groove 561 of the front plate 352, where the protruding length is set to be less than the maximum height of the expansion groove 561, and is bent at a right angle in the expansion groove 561 and disposed in the extension groove 562.

In some embodiments, the temperature measuring tip 341 of the thermocouple 340 may be minimally affected by the cover 350 exposed to the external environment. The temperature measuring tip 341 of the thermocouple 340 accurately measures and monitors the temperature of the pressed medium inside the vessel 20.

In the thermocouple 340, the temperature measuring tip 341 may be bent at a right angle in the expansion groove 561 and disposed in the extension groove 562. In this case, the expansion groove 561 of the front plate 352 may have a diameter of 5 mm to 20 mm and a depth of 5 mm to 20 mm, and the extension groove 562 may have a width of 5 mm to 20 mm. The diameter and depth of the expansion groove 561 and the width of the extension groove 562 can allow the pressed medium to sufficiently contact the temperature measuring tip 341 while reducing or preventing interference between the temperature measurement tip 341 and the vessel 20.

As the diameter and depth of the expansion groove 561 and the width of the extension groove 562 approach a maximum value of 20 mm, contact with the temperature measuring tip 341 and the pressed medium may increase to more accurately measure and monitor the temperature. The depth may be difficult to exceed 20 mm due to the structure of the front plate 352. As the diameter and depth of the expansion groove 561 and the width of the extension groove 562 approach 5 mm, the interval between the temperature measuring tip 241 and the front plate 352 decreases, so the temperature measuring tip 341 may be affected by the front plate 352.

Therefore, the diameter and depth of the expansion groove 561 and the width of the extension groove 562 may configured to reduce or prevent interference between the temperature measuring tip 341 of the front plate 352 and the vessel 20 to increase the contact area with the pressed medium.

In addition, the temperature measuring tip 341 may further protrude by a distance that is shorter than the interval between the inner surface of the front plate 350 of the cover 352 and the vessel 20 when the vessel 20 moves to the pressed position. In this case, the temperature measuring tip 341 is in further contact with the pressed medium, thereby more accurately measuring and monitoring the temperature of the pressed medium.

The covers 50, 250, and 350 of the first to third embodiments described above are used to extract and inject the vessel 20 into the isostatic pressing device of FIGS. 3 and 4. Hereinafter, for convenience, the cover 350 of the third embodiment will be described as an example.

FIG. 14 is a state diagram in which the vessel of the isostatic pressing device for an solid rechargeable battery according to the first embodiment of the present disclosure is opened and moves to an extraction or injection point. Referring to FIG. 14, the vessel 20 can be immediately extracted from the yoke 10 after the pressing process or can wait to be input into the yoke 10 for the pressing process. For convenience, it will be described later as a standby for injection.

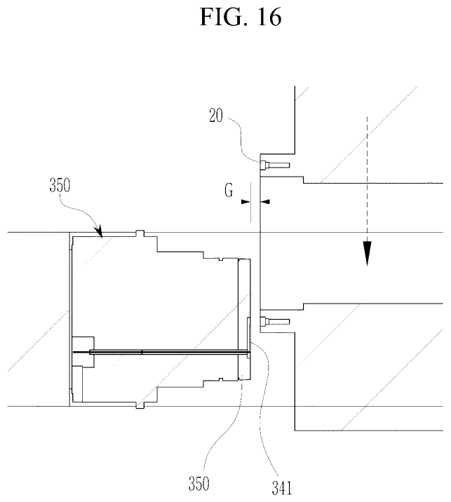

FIG. 15 is a diagram illustrating a state in which the vessel of the isostatic pressing device moves to a pressed position, following FIG. 14, and FIG. 16 is a cross-sectional view illustrating a state in which the interference between the inlet or outlet of a vessel and the thermocouple of the cover is reduced or prevented in the process of FIG. 15.

Referring to FIGS. 15 and 16, the vessel 20 is put into the yoke 10 in an injection standby state (see FIG. 14). In this case, the temperature measuring tip 341 located in the expansion groove 561 and the extension groove 562 of the front plate 352 of the cover 350 does not interfere with both ends of the vessel 20. Even if a gap G between the front plate 352 and the vessel 20 is 1 mm to 5 mm or less, no interference occurs.

FIG. 17 is a diagram illustrating a state in which the inlet or outlet of the vessel of the isostatic pressing device is closed with a cover, following the process of FIG. 15. Referring to FIG. 17, after the vessel 20 is input, the cover 350 provided on the yoke 10 moves in the axial direction to close the inlet and outlet at both ends of the vessel 20.

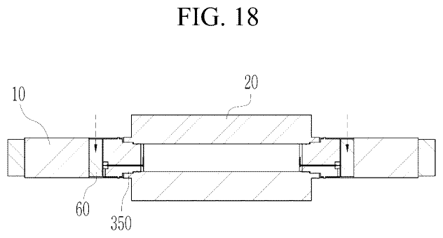

FIG. 18 is a pressed standby state diagram in which a block is inserted between a yoke and the cover of the isostatic pressing device, following the process of FIG. 17. Referring to FIG. 18, after the vessel 20 is closed with the cover 350, the block 60 is inserted between the yoke 10 and the cover 350 to form the pressed standby state.

What has been described above is only one embodiment for carrying out the all solid rechargeable battery according to the present disclosure. Therefore, the present disclosure is not limited to the above embodiments, and as claimed in the following claims, without departing from the gist of the present disclosure, it will be said that the technical features of the present disclosure are possible to the extent that various modifications can be made by a person with ordinary knowledge in the field to which the disclosure pertains.

### DESCRIPTION OF SYMBOLS

| | |
|---|---|
| 10: Yoke | 20: Vessel |
| 21: Internal space | 40: Thermocouple |
| 41: Temperature measuring tip | 50: cover |
| 51: Hole | 52: Front plate |
| 60: Block | 240: Thermocouple |
| 241: Temperature measuring tip | 252: Front plate |
| 250: Cover | 350: Cover |
| 352: Front plate | 521: Extension hole |
| 561, 256: Expansion groove | 562: Extension groove |

What is claimed is:

1. An isostatic pressing device for a battery, the device comprising:
a yoke;
a vessel installed inside the yoke, the vessel comprising a pressed medium;
a cover provided on the yoke to close and open an inlet and an outlet on the vessel; and
a thermocouple installed in a hole in the cover and configured to detect a temperature of the pressed medium,
wherein the thermocouple comprises a temperature measuring tip that protrudes from the hole in the cover to an inner surface of the cover, and the temperature measuring tip is in thermal contact with the pressed medium.

2. The isostatic pressing device of claim 1, further comprising:
a block inserted between the cover and the yoke.

3. The isostatic pressing device of claim 1, wherein:
the temperature measuring tip protrudes by a length that is shorter than an interval between the inner surface of the cover and the vessel while the vessel moves to a pressed position.

4. The isostatic pressing device of claim 3, wherein:
the temperature measuring tip protrudes 5 mm to 20 mm from the inner surface of the cover.

5. The isostatic pressing device of claim 1, wherein
the cover further includes a front plate formed on an inner surface of the cover, and
the front plate further includes an extension hole to extend the hole in the cover.

6. The isostatic pressing device of claim 5, wherein:
the temperature measuring tip protrudes from the extension hole of the front plate, and the temperature measuring tip protrudes 5 mm to 20 mm from the inner surface of the front plate.

7. An isostatic pressing device for a battery, the device comprising:
a yoke;
a vessel installed inside the yoke;
a cover provided on the yoke to close and open an inlet and an outlet on the vessel; and
a thermocouple installed in a hole in the cover and configured to detect a temperature of a pressed medium in the vessel,
wherein the cover has an expansion groove formed on an inner surface of the cover with a diameter larger than a diameter of the hole, and
wherein the thermocouple comprises a temperature measuring tip that protrudes from the expansion groove towards the inner surface of the cover, and the temperature measuring tip is in thermal contact with the pressed medium.

8. The isostatic pressing device of claim 7, wherein:
the expansion groove of the cover has a diameter of 5 mm to 20 mm and a depth of 5 mm to 20 mm.

9. The isostatic pressing device of claim 7, wherein:
the cover further includes a front plate formed on an inner surface of the cover,
the expansion groove is formed in the front plate, and
the temperature measuring tip is spaced apart from an inner surface of the expansion groove by a distance equal to a radius of the expansion groove.

10. The isostatic pressing device of claim 9, wherein:
the temperature measuring tip protrudes from an extension groove of the front plate by a protruding length, and
the protruding length of the temperature measuring tip is less than a maximum height of the expansion groove.

11. The isostatic pressing device of claim 10, wherein:
the expansion groove of the front plate has a diameter of 5 mm to 20 mm and a depth of 5 mm to 20 mm.

12. The isostatic pressing device of claim 10, wherein:
the protruding length is shorter than an interval between the inner surface of the front plate and the vessel when the vessel moves to a pressed position.

13. The isostatic pressing device of claim 7, wherein:
the cover further includes an extension groove connected to the expansion groove, and
the temperature measuring tip is bent in the expansion groove and spaced apart from an inner surface of the expansion groove and an inner surface of the extension groove.

14. The isostatic pressing device of claim 13, wherein:
the temperature measuring tip is bent at a right angle in the expansion groove and is disposed in the extension groove,
the expansion groove of the front plate has a diameter of 5 mm to 20 mm and a depth of 5 mm to 20 mm, and
a width of the extension groove is 5 mm to 20 mm.

15. The isostatic pressing device of claim 7, wherein:
the cover includes a front plate formed on an inner surface of the cover,
the front plate further includes an extension groove connected to the expansion groove, and
the temperature measuring tip is bent in the expansion groove and spaced apart from an inner surface of the expansion groove and an inner surface of the extension groove.

16. The isostatic pressing device of claim 15, wherein:
the temperature measuring tip is bent at a right angle in the expansion groove and disposed in the extension groove,
the expansion groove of the front plate has a diameter of 5 mm to 20 mm and a depth of 5 mm to 20 mm, and
a width of the extension groove is 5 mm to 20 mm.

17. The isostatic pressing device of claim 15, wherein:
the temperature measuring tip protrudes by a length that is shorter than an interval between the inner surface of the cover and the vessel when the vessel moves to the pressed position.
